(19) United States
(12) Patent Application Publication
(10) Pub. No.: US 2017/0036586 A1
(43) Pub. Date: Feb. 9, 2017

(54) VEHICULAR THERMAL DEVICE

(71) Applicant: Lawrence Jones, Roselle Park, NJ (US)

(72) Inventor: Lawrence Jones, Roselle Park, NJ (US)

(21) Appl. No.: 15/227,205

(22) Filed: Aug. 3, 2016

Related U.S. Application Data
(60) Provisional application No. 62/200,349, filed on Aug. 3, 2015.

(51) Int. Cl. B60N 3/10; B60R 11/02

(52) U.S. Cl. CPC B60N 3/104; B60R 11/0241; B60R 2011/0005

(57) ABSTRACT

A vehicular thermal device and article of manufacture are disclosed. In various embodiments, a vehicular thermal device having an interior chamber enclosed by at least one wall thereby forming an insulated compartment is disclosed. The vehicular thermal device also includes an arrangement to mount the insulated compartment to a location in a vehicle.

### CROSS REFERENCE TO RELATED APPLICATIONS

This application claims the benefit to U.S. Provisional Application No. 62/200,349, filed on Aug. 3, 2015, which application is incorporated herein by reference as if set forth in its entirety.

### FIELD OF THE INVENTION

The invention relates generally to insulated compartment and, more specifically, to a vehicular thermal device.

### BACKGROUND

On extremely hot or cold days, it can be dangerous for a person to leave valuable items in their car. The temperature can affect the items in a way that may destroy or alter such items such that the item may become inoperable. For example, the I-phone detects if the ambient temperature exceeds a threshold value and turns itself off and also alerts the user. Food items left in the car can also be damaged on harsh weather days. Therefore, there exists a need for a device that can store fragile and temperature sensitive items in a car.

### SUMMARY

Various deficiencies of the prior art are addressed by a vehicular thermal device. One embodiment comprises an interior chamber having at least one wall thereby forming an insulated compartment; said compartment comprising an aperture allowing access to the interior chamber; and an arrangement to mount said insulated compartment to a location in a vehicle; wherein the interior chamber maintains its ambient temperature stable.

Another embodiment comprises an article of manufacture, which includes an interior chamber having at least one wall thereby forming an insulated compartment; said compartment comprising an aperture allowing access to the interior chamber; and an arrangement to mount said insulated compartment to a location in a vehicle; wherein the interior chamber maintains its ambient temperature stable.

### BRIEF DESCRIPTION OF THE DRAWINGS

The teachings of the present invention can be readily understood by considering the following detailed description in conjunction with the accompanying drawings, in which:

FIG. 1 depicts a front perspective view of a vehicular thermal device according to an embodiment;

FIG. 2 depicts a top view of the vehicular thermal device according to the embodiment depicted in FIG. 1;

FIG. 3 depicts a side view of the vehicular thermal device according to the embodiment depicted in FIG. 1;

FIG. 4 depicts a front perspective view of a vehicular thermal device according to an embodiment;

FIG. 5 depicts the right side view of the vehicular thermal device according to the embodiment depicted in FIG. 4; and

FIG. 6 depicts a front perspective of the vehicular thermal device according to the embodiment depicted in FIG. 4.

To facilitate understanding, identical reference numerals have been used, where possible, to designate identical elements that are common to the Figures.

### DETAILED DESCRIPTION

The invention will be primarily described within the context of particular embodiments; however, those skilled in the art and informed by the teachings herein will realize that the invention is also applicable to other technical areas and/or embodiments.

The illustrative vehicular thermal device means for and article of manufacture embodiments described herein are not meant to be limiting. It may be readily understood that certain aspects of the disclosed vehicular thermal device, means for and article of manufacture can be arranged and combined in a variety of different configurations, all of which are contemplated herein.

Generally speaking, the various embodiments enable, support and/or provide a new paradigm that can change the interior architecture of all vehicles. Specifically, there are no devices that cater to the need for a device that can store valuable, temperature sensitive and fragile items in a vehicle. A vehicular thermal device can be carefully integrated in the interior design of the vehicle to augment the intimate relationship that the driver experiences. The functional design and development of a modern motor vehicle is typically done by a large team from many different disciplines included within automotive engineering. Automotive design in this context is primarily concerned with developing the visual appearance or aesthetics of the vehicle, though it is also involved in the product concept phase. The stylist responsible for the design of the vehicle interior develops the proportions, shape, placement and surfaces for the instrument panel, seats, door trim panels, headliner, pillar trims, etc. Here, the emphasis is on ergonomics and the comfort of the vehicle's occupants. Just as the placement of an ashtray is strategic, so too is the placement of a style or model of the vehicular thermal device should be strategic. The vehicular thermal device can be placed in the dashboard, the center console, the glove compartment, the sun visor or in between the backseats of a vehicle. The vehicular thermal device can also be portable.

The vehicular thermal device protects everyday items such as sun glasses, cell phones, I-phones, smart devices, medicine, food, and drink from thermal damage. Most products are designed to operate at room temperature, which is about 25° C. Most products can withstand exposure to temperatures much below or above room temperature however, not for a prolonged period of time or on a recurring basis.

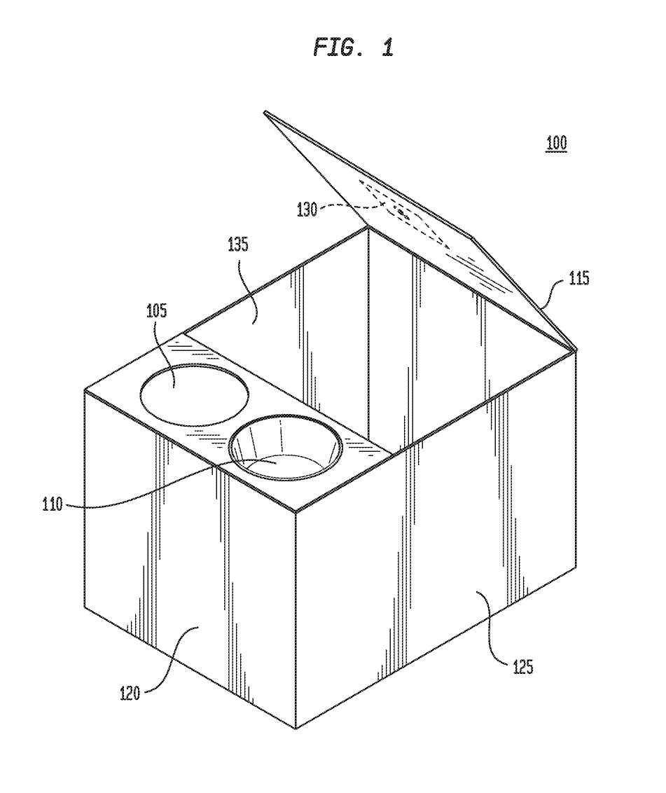

Referring to FIG. 1, the center console of a vehicle is shown incorporating vehicular thermal device 100 according to an embodiment. In some embodiments, the traditional cup 105 and key holders 110 occupy a portion of the center console whereas the remaining portion houses the vehicular thermal device. In this embodiment, vehicular thermal device 100 includes a flap 115, which when open allows access to the chamber where the items are stored. Flap 115 is opaque in some embodiments. In other embodiments, flap 115 is transparent 130. In yet other embodiments, flap 115 incorporates a slider 130 allowing access to the chamber without having to fully open flap 115. In other embodiments, slider 130 includes a lock. The chamber interior maintains its ambient environment constant due to the insulated walls. However, the interior appearance or finish is decorative, texturized or plain. In some embodiments, the interior incorporates design and patterns in harmony with the interior design of the vehicle. Depth 120 of the chamber is proportional to the overall dimensions of vehicular thermal device 100. The interior volume of the vehicle being limited, so too is the volume of vehicular thermal device 100. Accordingly, the overall dimensions (H,W,L) of vehicular thermal device 100 are a function the total volume allocated for such purpose. In some embodiment, flap 115 is located on the side (120,125) of the console.

In one embodiment, the interior of chamber 125 is made of waterproof or impermeable material. The material can be plain in color and style. In other embodiments, the material is colorful and incorporates a design pattern. The interior can also include perforations as part of the design. In some embodiments, the material is regular clothing material, such as fabric made of cotton, flax, wool, ramie, silk, denim, leather and the like. In yet other embodiments, the interior of chamber 125 is made out of metal.

The interior of chamber 125 comprises at least one wall 135. In some embodiments, the interior of chamber 125 comprises four walls, which are insulated. One wall is heavily insulated whereas the next wall is lightly insulated. The amount of insulation depends on the location of the wall in relationship to the heat intensity that the wall is exposed to and the conduction properties of the material used to construct the wall of the chamber. In some embodiments, vehicular thermal device includes a thermo-sensor connected to the heating and air-conditioning system of the vehicle.

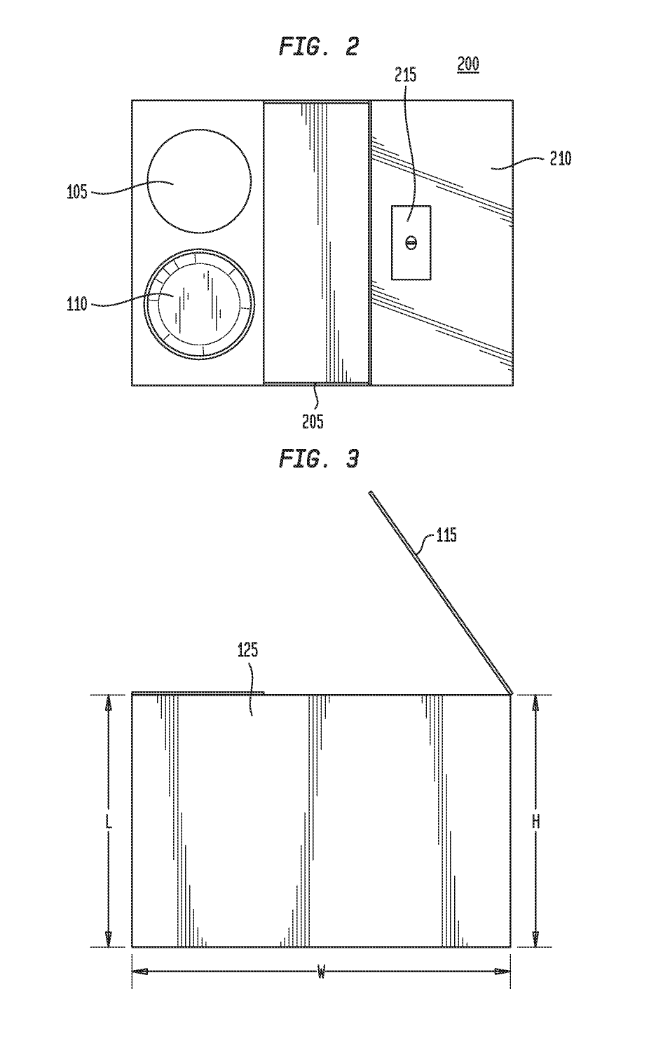

FIG. 2 depicts a top view of the vehicular thermal device according to the embodiment depicted in FIG. 1. As articulated above, vehicular thermal device 100 includes a flap 215, which when open allows access to the chamber where the items are stored. Flap 215 is opaque in some embodiments. In other embodiments, flap 215 is transparent. In yet other embodiments, flap 215 incorporates a slider allowing access to the chamber without having to fully open flap 215. In other embodiments, flap 215 includes a lock. The chamber interior 210 maintains its ambient environment constant due to the insulated walls. In some embodiments, vehicular thermal device includes a thermo-sensor connected to the heating and air-conditioning system of the vehicle.

FIG. 3 depicts a side view of the vehicular thermal device according to the embodiment depicted in FIG. 1. As shown, the overall dimensions (H,W,L) of vehicular thermal device 100 is a function the total volume allocated for such purpose. In some embodiment, flap 115 is located on the side (120,125) of the console, In some embodiments, H, W and L are the same dimensions. In other embodiments, these dimensions are different. For example, when vehicular thermal device is installed in the rear console (between the back seats) of the vehicle, H, W and L vary accordingly.

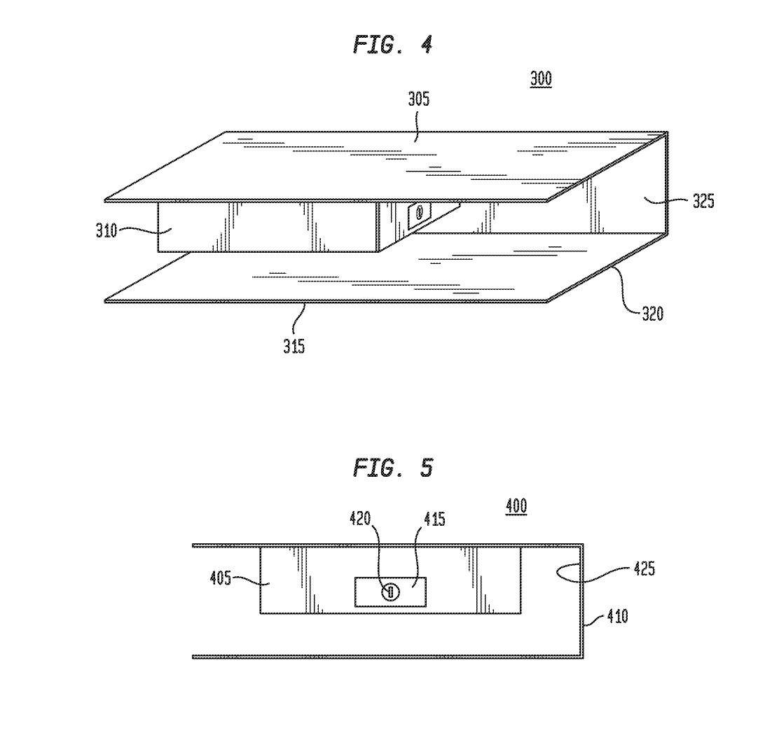

FIG. 4 depicts a front perspective view of a vehicular thermal device according to an embodiment. In one embodiment, structure 300 is a glove compartment. In other embodiments, structure 300 is the vehicle's sun visor. In this embodiment, surface 305 is adapted to mount the vehicular thermal device in the sun visor or near the rear view mirror.

In this embodiment, vehicular thermal device 100 includes an aperture 310, which allows access to the chamber where the items are stored. The chamber being in the glove compartment maintains its ambient environment constant due to the insulated walls. The volume of the glove compartment of the vehicle being limited, so too is the volume of vehicular thermal device 100. Accordingly, the overall dimensions of vehicular thermal device 100 are a function the total volume allocated for such purpose.

In one embodiment, the interior of chamber 125 is made of waterproof or impermeable material. The material can be plain in color and style. In other embodiments, the material is colorful and incorporates a design pattern. In some embodiments, the material is regular clothing material, such as fabric made of cotton, flax, wool, ramie, silk, denim, leather and the like. In yet other embodiments, the interior of chamber 125 is made out of metal.

The interior of chamber 125 comprises at least one wall 505. In some embodiments, the interior of chamber 125 comprises four walls, which are insulated. One wall is heavily insulated whereas the next wall is lightly insulated. The amount of insulation depends on the location of the wall in relationship to the heat intensity that the wall is exposed to and the conduction properties of the material used to construct the wall of the chamber.

FIG. 5 depicts the right side view of the vehicular thermal device according to the embodiment depicted in FIG. 4. In this embodiment, vehicular thermal device 100 includes a flap or door 415, located on side 405 of the compartment. Flap 415 when open allows access to the chamber where the items are stored. Flap 415 is opaque in some embodiments. In other embodiments, flap 415 is transparent. In yet other embodiments, flap 415 incorporates a handle 420 allowing access to the chamber. In some embodiments, the handle includes a lock. The chamber interior maintains its ambient environment constant due to the insulated walls, However, the interior appearance or finish is decorative, texturized or plain. In some embodiments, the interior incorporates design and patterns in harmony with the interior design of the vehicle. Depth 120 of the chamber is proportional to the overall dimensions of vehicular thermal device 100. The interior volume of the vehicle being limited, so too is the volume of vehicular thermal device 100. Accordingly, the overall dimensions of vehicular thermal device 100 are a function the total volume allocated for such purpose. Accordingly, vehicular thermal device 100 could utilize panel 320 as a wall.

In one embodiment, the interior of chamber 125 is made of waterproof or impermeable material. The material can be plain in color and style. In other embodiments, the material is colorful and incorporates a design pattern. In some embodiments, the material is regular clothing material, such as fabric made of cotton, flax, wool, ramie, silk, denim, leather and the like. In yet other embodiments, the interior of chamber 125 is made out of metal.

The interior of chamber 125 comprises at least one wall 425. In some embodiments, the interior of chamber 125 comprises four walls, which are insulated. One wall is heavily insulated whereas the next wall is lightly insulated. The amount of insulation depends on the location of the wall in relationship to the heat intensity that the wall is exposed to and the conduction properties of the material used to construct the wall of the chamber. For example, in this embodiment, panel 410 is located near the engine in some vehicles. Therefore, the walls closer to panel 425 would require different insulation scheme than walls located farther from panel 425.

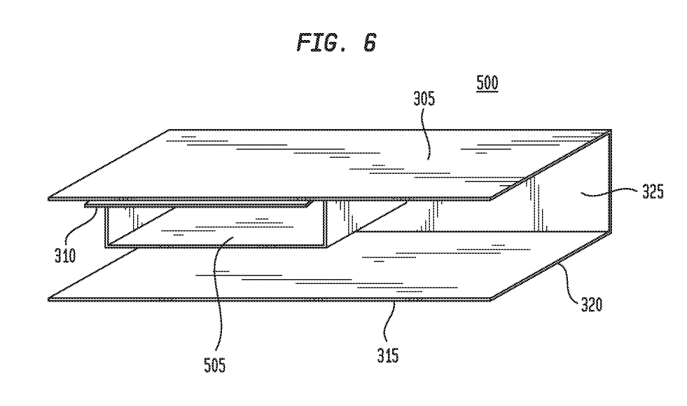

FIG. 6 depicts a front perspective of the vehicular thermal device according to the embodiment depicted in FIG. 4. This embodiment includes a flap or door 510 although flap or door 510 is shown retracted to reveal interior 505 of the chamber. In this embodiment, the compartment only occupies a portion of the usable space. There is room to store other items such as vehicle registration, insurance ID card and the like.

Although various embodiments, which incorporate the teachings of the present invention have been shown and described in detail herein, those skilled in the art can readily devise many other varied embodiments that still incorporate these teachings. For example, a combination of stamping process and high-speed manufacturing can be used to produce composite structure 100.

It is contemplated that some of the steps discussed herein as manufacturing methods may be implemented manually.

We claim:

1. A vehicular thermal device, comprising,:
an interior chamber having at least one wall thereby forming an insulated compartment;
said compartment comprising an aperture allowing access to the interior chamber; and
an arrangement to mount said insulated compartment to a location in a vehicle;
wherein the interior chamber maintains its ambient temperature stable.

2. The vehicular thermal device of claim 1, wherein the at least one wail comprises an inner surface and an outer surface.

3. The vehicular thermal device of claim 2, wherein thermal insulated material comprises a layer between the inner surface and the outer surface of the at least one wall.

4. The vehicular thermal device of claim 3, wherein the inner surface is configured to allow minimal temperature variations within the environment of the interior chamber.

5. The vehicular thermal device of claim 1, wherein the outer surface is configured to keep temperature variations from the environment of the interior chamber.

6. The vehicular thermal device of claim 5, wherein the outer surface aesthetic blends In with the interior of the vehicle.

7. The vehicular thermal device of claim 1, wherein the arrangement is configured to be mounted on the center console of the vehicle.

8. The vehicular thermal device of claim 1, wherein the arrangement is configured to be mounted in the glove compartment of the vehicle.

9. The vehicular thermal device of claim 1, wherein the arrangement is configured to be mounted in the sun visor of the vehicle.

10. The vehicular thermal device of claim 9, wherein a hinged lid provides access to the interior chamber of the insulated compartment.

11. An article of manufacture, comprising:
an interior chamber having at least one wall thereby forming an insulated compartment;
said compartment comprising an aperture allowing access to the interior chamber; and
an arrangement to mount said insulated compartment to a location in a vehicle;
wherein the interior chamber maintains its ambient temperature stable.

12. A vehicular thermal device, comprising:
means for providing an interior chamber having at least one wall thereby forming an insulated compartment;
said compartment comprising an aperture allowing access to the interior chamber; and
means for providing an arrangement to mount said insulated compartment to a location in a vehicle;
wherein the interior chamber maintains its ambient temperature stable.
